(19) United States
(12) Patent Application Publication
(10) Pub. No.: US 2020/0249767 A1
(43) Pub. Date: Aug. 6, 2020

(54) Virtual Keyboard Input Method

(71) Applicant: Justin King, Vienna, VA (US)

(72) Inventor: Justin King, Vienna, VA (US)

(21) Appl. No.: 16/265,671

(22) Filed: Feb. 1, 2019

(51) Int. Cl. G06F 3/023

(52) U.S. Cl. CPC G06F 3/0233

(57) ABSTRACT

A method for inputting without keyboard is provided. The method for inputting without keyboard includes determining which finger has an action and generating a first signal; determining a moving position of the finger and generating a second signal; and mapping a character for input operation based on the first signal and the second signal.

### BACKGROUND OF INVENTION

The present invention relates to an input method, and more particularly to an input method without keyboard.

Traditional PCs or other computer systems use the keyboard for input, but now that portable personal electronic devices have become indispensable devices in people's daily life. Portable personal electronic devices use touch panels or small keyboards for input, but they are inconvenient and not inputting as fast as conventional large keyboards when one need to input words. Although the invention of a portable keyboard is announced, but it's still too bulky and inconvenient to carry. Therefore, there is a need for a portable and rapid inputting method.

### SUMMARY OF THE INVENTION

The present invention provides a method for inputting, in particular a method for inputting without keyboard. The present invention provides an input method that allows quick and easy input. And to avoid the mistouching of the left hand keys by the right hand or the mistouching of the right hand keys by the left hand when inputting with physical keyboard.

The method for inputting without keyboard according to an embodiment of the present invention includes determining which finger has an action and generating a first signal; determining a moving position of the finger and generating a second signal; and mapping a character for input operation based on the first signal and the second signal.

According to an embodiment of input method without keyboard, wherein the step of generating the second signal further includes determining at least three movement positions that the finger is moved.

According to an embodiment of the input method without keyboard, wherein the step of generating the second signal further includes determining at least two movement positions that the finger is moved when the finger is determined to be a thumb according to the first signal.

According to an embodiment of the input method without keyboard, wherein the step of generating the second signal further includes determining at least six movement positions that the finger is moved when the finger is determined to be an index finger according to the first signal.

According to an embodiment of the input method without keyboard, wherein the step of generating the second signal further includes determining at least three movement positions that the finger is moved when the finger is determined to be one of the middle finger, ring finger, or little finger according to the first signal.

According to an embodiment of the present invention, the input method without keyboard further includes combining a plurality of first signals and second signals to correspond to an input operation.

According to an embodiment of the present invention, the input method without keyboard further includes an optical element detecting which finger has an action and detecting the movement position of the finger.

According to an embodiment of the present invention, the input method without keyboard further includes an angle detecting device disposed on the finger to detect which finger has an action and to detect the movement position of the finger.

According to an embodiment of the present invention, the input method without keyboard further includes an acceleration detecting element disposed on the finger to detect which finger has an action and to detect the movement position of the finger.

According to an embodiment of the present invention, the input method without keyboard further includes a plurality of pressure detecting elements disposed on a finger to detect which finger has an action and to detect the movement position of the finger.

By the step of determining which finger is in motion and generating a first signal and the step of determining the moving position of the finger and generating a second signal, the input method according to an embodiment of the present invention still can carry on the quick input operation without a physical keyboard. Since mapping a character input operation by the first signal and the second signal, the circumstance that the left hand keys mistouching by right hand or the right hand keys mistouching by left hand when inputting with keyboard can be prevented.

### BRIEF DESCRIPTION OF THE DRAWINGS

The present invention will now be specified with reference to its preferred embodiment illustrated in the drawings, in which:

FIG. 1 is a schematic view of the steps of an embodiment of the present invention.

FIG. 2 is a schematic view of the movement positions of a finger of an embodiment of the present invention.

FIG. 3 is a schematic view of three movement positions of a finger of an embodiment of the present invention.

FIG. 4 is a schematic view of two movement positions of a finger of an embodiment of the present invention.

FIG. 5 is a schematic view of six movement positions of a finger of an embodiment of the present invention.

FIG. 6 is a schematic view of detecting finger by an optical element of an embodiment of the present invention.

FIG. 7 is a schematic view of detecting finger by an angle detecting device of an embodiment of the present invention.

FIG. 8 is a schematic view of detecting the index finger by an angle detecting device of an embodiment of the present invention.

FIG. 9 is a schematic view of detecting finger by an acceleration detecting element of an embodiment of the present invention.

FIG. 10 is a schematic view of detecting finger by a plurality of pressure detecting elements of an embodiment of the present invention.

### DESCRIPTION OF THE INVENTION

The embodiments of the invention will be described below with reference to the drawings. It should be understood that the specific embodiments described herein are merely illustrative of the invention and are not intended to limit the invention. The figures reveal some details. It should be understood that the details of the figures may be different from those that have been disclosed in words unless explicitly limiting the characteristics in specification.

In the description, it should be understood that the terms “longitudinal”, “horizontal”, “upper”, “lower”, “front”, “rear”, “left”, “right”, “Horizontal”, “top”, “bottom”, “inside”, “outside” and the like are based on the orientation or positional relationship shown in the drawings only for the purpose of describing the invention, it is not instructions or implied means that the device or element must have a specific orientation, constructed and operated in a particular orientation, and therefore it should not be construed as limiting the invention.

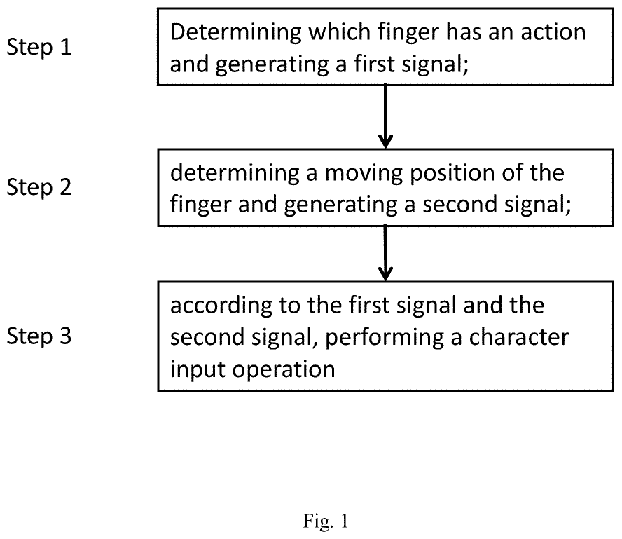

As shown in FIG. 1, According to an embodiment of the present invention, a input method without keyboard includes step 1: determining which finger has an action and generating a first signal; step 2: determining a movement position of the finger and generating a second signal; and step 3: mapping a character for input operation based on the first signal and the second signal. The step for determining which finger has an action includes determining whether it is on left hand or right hand and, in general, determining which fingers for each hand, for example, thumb, index finger, middle finger, ring finger and little finger. The execution order of step 1 and step 2 can be step 1 first or step 2 first or execution at the same time.

Further, the first signal can include a first reference information for the finger's initial state or position, the second signal can include a second reference information for the finger's movement and relative new position the finger has moved to from the initial position. The first reference information and the second reference information provide the series of motion that the particular finger has performed.

The first reference information and the second reference information are detected by the detecting element positioned/wore on the fingers, and are forwarded wirelessly to a host for processing as a regular keyboard sends the signal representing each key stroke user enter on a physical keyboard. The first reference information and the second reference information are capturing the finger movement as the finger is striking a particular key on a keyboard. A host for processing the reference information can be a computer, a cell phone, or any device which can accept or is compatible with keyboard entry.

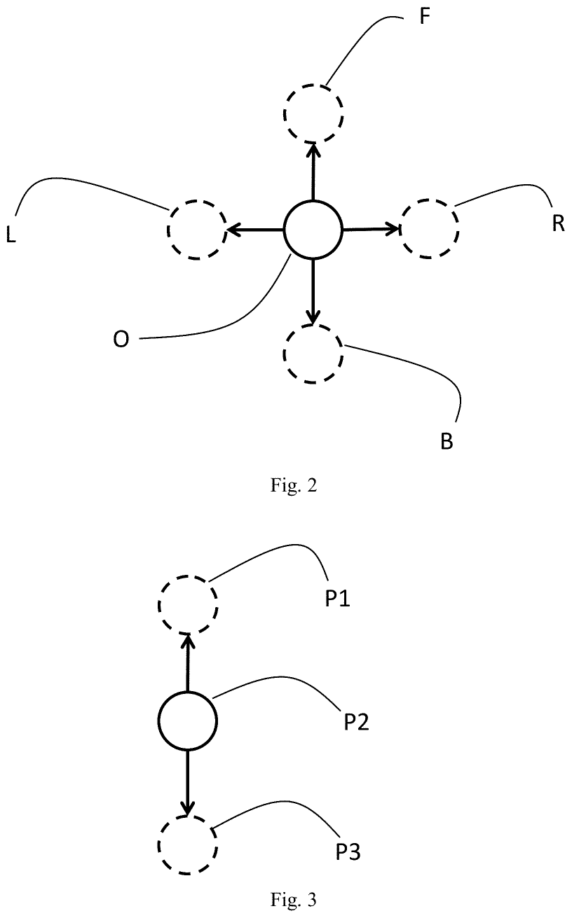

As shown in FIG. 2, determining the movement position of the finger, for example, moved forwards F or moved backward B relative to the original fingertip position O. Or moved left L or moved right R relative to the original fingertip position O.

In the input method according to an embodiment of the present invention, wherein the step of generating the second signal further includes determining at least three positions that the finger is moved. Referring to FIG. 3, for example, the forward movement position relative to the position of the original fingertip position may be designated as a first position P1, the position of the original fingertip may be designated as a second position P2, and the backward movement position relative to the position of the original fingertip position may be designated as a third position P3.

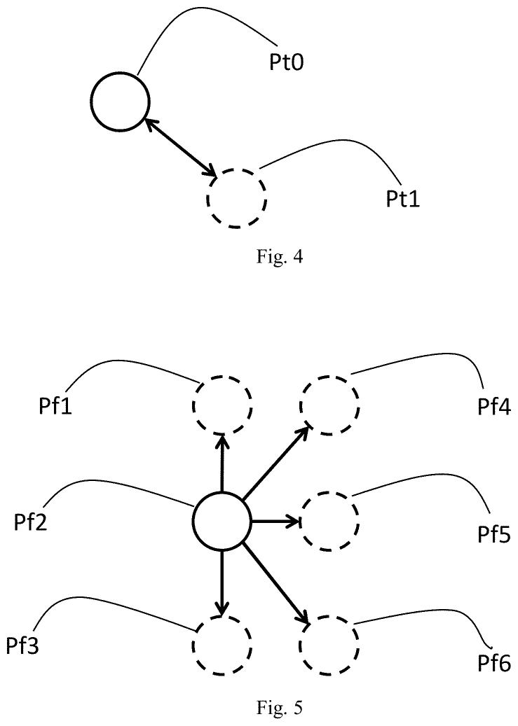

As shown in FIG. 4, in the input method according to an embodiment of the present invention, wherein the step of generating the second signal by further includes determining at least two movement positions that the finger is moving when the finger is determined to be a thumb according to the first signal. For example of the left hand, the original position of the left thumb tip is designated as a first position Pt1 and the moving position relative to the original position of the left thumb tip is designated as a second position Pt2.

As shown in FIG. 5, in the input method according to an embodiment of the present invention, wherein the step of generating the second signal further includes determining at least six movement positions that the finger is moving when the finger is determined to be the index finger according to the first signal. Taking the left hand as an example, the forward moving position relative to the original position of the left hand index fingertip is designated as a first position Pf1, the original position is designated as a second position Pf2, the backward moving position relative to the original position is designated as a third position Pt3, The forward and rightward movement relative to the original position is designated as a fourth position Pt4, the rightward movement relative to the original position is designated as a fifth position Pt5, and the backward and rightward movement relative to the original position is designated as a sixth position Pt6. In the present invention, since the right and left hands need not have to be placed in the space close to each other as inputting with physical keyboard, the left index finger mistouching the right hand keys or the right index finger mistouching the left hand keys when inputting with the physical keyboard is averted.

Please Referring to FIG. 3, in the input method according to an embodiment of the present invention, wherein the step of generating the second signal further includes determining at least three movement positions that the finger is moving when the finger is determined to be one of the middle finger, ring finger, or little finger according to the first signal. For example, the forward movement position relative to the original position of the fingertip is designated as a first position P1, the original position of the fingertip is designated as a second position P2, and the backward movement position relative to the original position of the fingertip is designated as a third position P3.

The input method according to an embodiment of the present invention further includes mapping to an input operation by combining a plurality of first signals and second signals. For example, a combination of first signals and second signals generated by of five fingers corresponds to an input operation. In detail, for example, a combination of first signals and second signals generated by making a first action of five fingers correspond to a start input operation. A combination of first signals and second signals generated by the stretching action of five fingers correspond to an ending input operation, and vice versa. That is, a combination of first signals and second signals generated by making a first action of five fingers correspond to an ending input operation. A combination of first signals and second signals generated by the stretching action of five fingers correspond to a start input operation. For example, a combination of first signals and second signals of five fingers moving in the same direction corresponds to a cursor movement input operation.

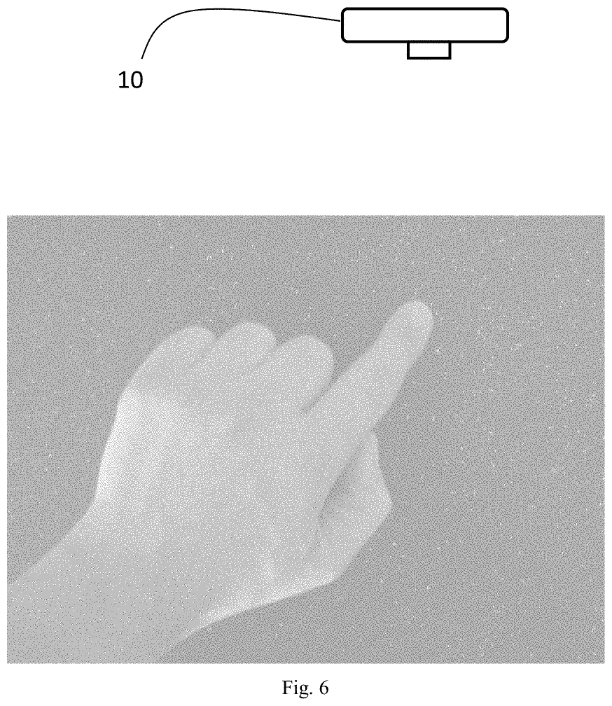

Referring to FIG. 6, in the input method according to an embodiment of the present invention, an optical element 10 detects which finger has an action and detects the moving position of the finger. For example, an external video camera or a video camera embedded into a portable personal electronic device is used to capture images of the hand, and then determining which finger has an action and determining the relative moving position of the finger to by a processor based on the images captured by the camera and generate the first signal and the second signal correspondingly.

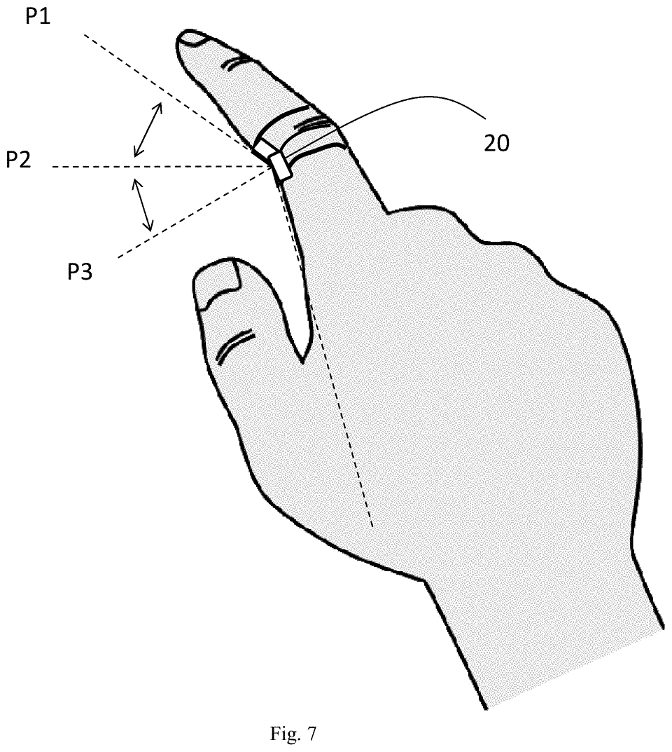

Referring to FIG. 7, in the input method according to an embodiment of the present invention, an angle detecting element 20 disposed on a finger detects whether a finger has an action and detects a moving position of the finger. For example, the forward movement position relative to the original position of the fingertip is designated as a first position P1, the original position of the fingertip is designated as a second position P2, and the backward movement position relative to the original position of the fingertip is designated as a third position P3. The angle of the finger at the first position P1 is the largest, the angle of the finger at the second position P2 is second, and the angle of the finger at the third position P3 is the smallest. Therefore, the second signal can be generated according to the detected angle of the angle detection element 20. In FIG. 7, an angle detecting element 20 disposed on the right hand index finger is taken as an example. An angle detecting element 20 may also be disposed on different position of the finger or on other fingers to detect the movement of the finger.

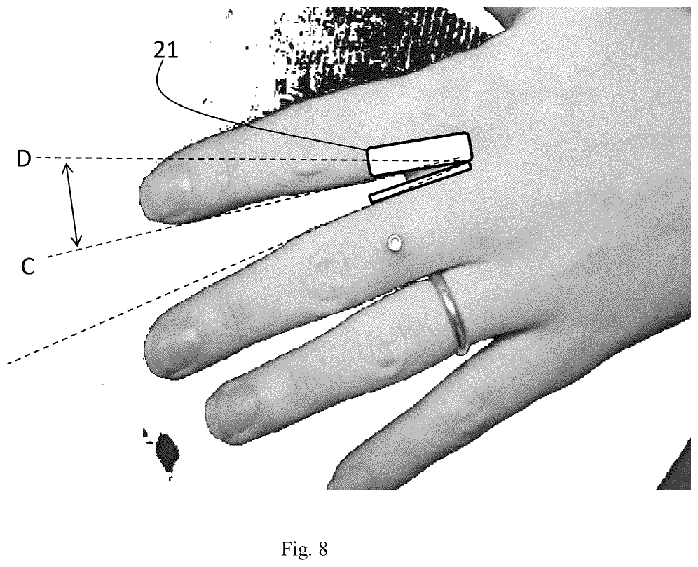

Referring to FIG. 8, taking the right hand index finger as an example, in order to determine the six positions of the finger, the angle detecting element 21 can be disposed between the index finger and middle finger to determine the angle between the index finger and the middle finger to determine whether the index finger is moving away from the middle finger. For example, the second signal may include three positions P1, P2, and P3, and the third signal may include close position C and distance position D, the combination of the second signal and the third signal can represent six locations.

In the input method according to an embodiment of the present invention, the angle detecting element may be disposed on the glove for wearable purposes. These embodiments of the present invention do not need to limit the type and position where the angle detecting element disposed.

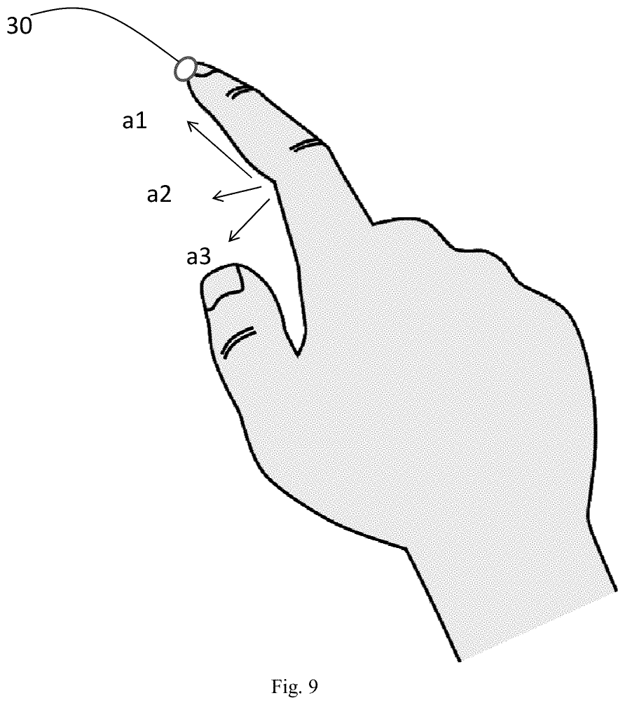

Referring to FIG. 9, in the input method according to an embodiment of the present invention, an acceleration detecting element 30 disposed on a finger is used to detect which finger has an action and to detect a moving position of the finger. For example, the forward movement position relative to the original position of the fingertip is designated as a first position P1, the position of the original fingertip is designated as a second position P2, and the backward movement position relative to the original position of the fingertip is designated as a third position P3. When the finger moves toward the first position P1, a first acceleration direction a1 is detected. When the finger moves toward the second position P2, a second acceleration direction a2 is detected. When the finger moves toward the third position P3, a third acceleration direction a3 is detected. Therefore, the second signal may be generated according to different acceleration directions detected by the acceleration detecting element 30. In FIG. 9, an acceleration detecting element 30 mounted on the right hand index finger is taken as an example. An acceleration detecting element may also be mounted on other position of the finger of on other fingers to detect the movement of the finger.

In the input method according to an embodiment of the present invention, the acceleration detecting element 30 may be disposed on the glove for wearable purposes. Further, a glove can be equipped the detecting elements to implement the instant invention.

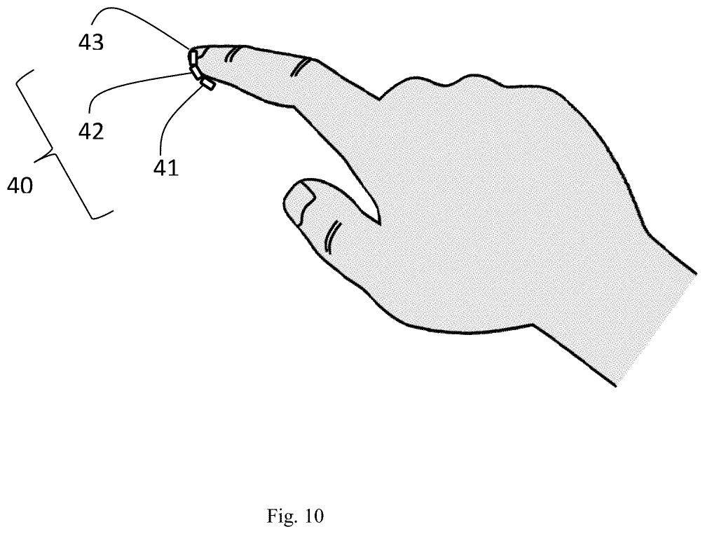

Referring to FIG. 10, in the input method according to the embodiment of the present invention, a plurality of pressure detecting elements 40 disposed on a finger may be used to detect which finger has an action and detect a moving position of the finger. For example, the first pressure sensing element 41, the second pressure sensing element 42 and the third pressure sensing element 43 are respectively disposed at three positions of the fingertip. The forward movement position relative to the original position of the fingertip is designated as a first position P1, the original position of the fingertip is designated as a second position P2, and the backward movement position relative to the original position of the fingertip is designated as a third position P3. When the finger moves to the first position P1, the first pressure detecting element 41 detects the change of pressure and send a pressure signal. When the finger moves to the second position P2, the second pressure detecting element 42 detects the change of pressure and send a pressure signal. And the finger moves to the third position P3, The third pressure detecting element 43 detects the change of pressure and send a pressure signal. Therefore, the second signal can be generated according to which pressure detecting element 40 generates the pressure signal.

In FIG. 10, the pressure sensing element 40 mounted on the right hand index finger is used as an example. A pressure sensing element may also be mounted on other position of the finger or on other fingers to detect the movement of the finger.

In the input method according to an embodiment of the present invention, the pressure detecting element may be disposed on the glove for wearable purposes.

In the input method according to an embodiment of the present invention, at least two of the optical element 10, the angle detection element 20, the acceleration detection element 30 and the pressure detection element 40 may also be combined to perform finger movement detection.

In the input method according to an embodiment of the present invention, a learning mode can also be implemented to memorize user's finger movements in associating with particular keyboard keys in order to accommodate each user and improve accuracy in associating finger movements to keyboard key.

These embodiments of the present invention do not need to limit the type and position of the detecting elements.

The above description is a preferred embodiment of the invention and it should be noted that it will be apparent to those skilled in the art that a number of improvements and modifications may be made without departing from the principles of the invention. These improvements and modifications also regarded as the scope of protection of the invention.

What is claimed is:

1. A method for inputting without keyboard, comprising:
determining which finger has an action and generating a first signal;
determining a moving position of said finger and generating a second signal; and
mapping a character for input operation based on said first signal and said second signal.

2. The method for inputting without keyboard of claim 1, wherein said step of generating said second signal further comprises determining at least three movement positions that said finger is moved.

3. The method for inputting without keyboard of claim 1, wherein said step of generating said second signal further comprises determining at least two movement positions that said finger is moved when said finger is determined to be a thumb according to said first signal.

4. The method for inputting without keyboard of claim 1, wherein said step of generating said second signal further comprises determining at least six movement positions that said finger is moved when said finger is determined to be an index finger according to said first signal

5. The method for inputting without keyboard of claim 1, wherein said step of generating said second signal further comprises determining at least three movement positions that said finger is moved when said finger is determined to be one of the middle finger, ring finger, or little finger according to said first signal.

6. The method for inputting without keyboard of claim 1 further comprises combining a plurality of said first signals and said second signals to correspond to an input operation.

7. The method for inputting without keyboard of claim 1 further comprises an optical element detecting which finger has an action and detecting the movement position of said finger.

8. The method for inputting without keyboard of claim 1 further comprises an angle detecting device disposed on said finger to detect which finger has an action and to detect the movement position of said finger.

9. The method for inputting without keyboard of claim 1 further comprises an acceleration detecting element disposed on said finger to detect which finger has an action and to detect the movement position of said finger.

10. The method for inputting without keyboard of claim 1 further comprises a plurality of pressure detecting elements disposed on said finger to detect which finger has an action and to detect the movement position of said finger.
